(19) United States
(12) Patent Application Publication
(10) Pub. No.: US 2024/0321107 A1
(43) Pub. Date: Sep. 26, 2024

(54) VEHICLE CONTROL DEVICE AND VEHICLE TRAVELING SYSTEM

(71) Applicant: Mitsubishi Electric Corporation, Tokyo (JP)

(72) Inventors: Haiyue ZHANG, Tokyo (JP); Nariaki TAKEHARA, Tokyo (JP); Tadahiko URANO, Tokyo (JP); Takatoshi KAKUTA, Tokyo (JP); Keisuke MORITA, Tokyo (JP)

(73) Assignee: Mitsubishi Electric Corporation, Tokyo (JP)

(21) Appl. No.: 18/426,913

(22) Filed: Jan. 30, 2024

(30) Foreign Application Priority Data
Mar. 24, 2023 (JP) 2023-047903

(51) Int. Cl. G08G 1/16; B60W 60/00; G08G 1/01

(52) U.S. Cl. CPC G08G 1/167; B60W 60/0015; G08G 1/0116; G08G 1/164; B60W 2556/35; B60W 2556/45

(57) ABSTRACT

This vehicle control device includes an own-position acquisition unit, a sensor unit which performs detection at least frontward of a vehicle, a route generation unit which generates a vehicle traveling route, and a control unit which performs vehicle driving control. The route generation unit includes a route calculation unit which calculates the vehicle traveling route, and a traveling determination unit which determines whether traveling is possible on the calculated traveling route. The route calculation unit generates a first traveling route for avoiding an object on the basis of the acquired object information. The traveling determination unit determines whether the first traveling route passes through a blind spot area, and if the route is determined to pass through the blind spot area, estimates whether the sensor unit of the vehicle can detect the blind spot area on the assumption that the vehicle travels on the first traveling route.

### BACKGROUND OF THE INVENTION

### 1. Field of the Invention

The present disclosure relates to a vehicle control device and a vehicle traveling system.

### 2. Description of the Background Art

A conventional vehicle traveling system recognizes the position and the like of an object in a predetermined area as object information by a road side unit (RSU) which is a device provided on a roadside, and provides the object information to an automated driving vehicle in the area. More specifically, a server processes the object information acquired by the road side unit RSU and sends the processed information to an automated driving vehicle in the area. The automated driving vehicle determines a traveling route in consideration of the object information and travels on the basis of the traveling route. With this configuration, even an automated driving vehicle not having a sensor for detecting the surrounding environment can travel through automated driving in the area.

However, since the road side unit RSU is often provided so as to monitor the ground from a high place, there is an area that cannot be detected by being hidden behind an object on the ground, i.e., a blind spot area which is an area as a blind spot for the road side unit RSU due to the object. In a case where there is an obstacle in such a blind spot area for which the road side unit RSU cannot recognize the situation, there is a possibility that an automated driving vehicle passing in the blind spot area collides with the obstacle. Therefore, it has been required that the blind spot area is predicted or compensated to enable usage of the area in automated driving or the like.

For such a problem, the applicant has proposed a vehicle traveling system including a device that can estimate a blind spot area (see Patent Document 1).
Patent Document 1: Japanese Laid-Open Patent Publication No. 2022-100793

According to Patent Document 1, on the basis of object information which is information about an object in a predetermined area detected by a detection unit, an object area which is an area of the object is acquired, and on the basis of the object area, a blind spot area which is an area as a blind spot for the detection unit due to the object is estimated. Then, if the blind spot area is estimated to be due to a static object, the automated driving vehicle determines a traveling pattern for avoiding the blind spot area, and if the blind spot area is estimated to be due to a moving object, the automated driving vehicle stops and waits at a position before the blind spot area.

However, efficient traffic of vehicles and advancement of automated driving are required, so that the waiting period for the blind spot area needs to be reduced.

### SUMMARY OF THE INVENTION

The present disclosure has been made to solve the above problem, and an object of the present disclosure is to provide a vehicle control device and a vehicle traveling system that can reduce the waiting period for the blind spot area.

A vehicle control device according to the present disclosure is a vehicle control device which controls traveling of a vehicle while acquiring object information about an object detected by a road side unit, and blind spot information including a blind spot area as a blind spot for the road side unit due to the object, estimated on the basis of the object information, the vehicle control device including: an own-position acquisition unit which acquires a position of the vehicle; a sensor unit which performs detection at least frontward of the vehicle; a route generation unit which generates a traveling route on which the vehicle travels, using the position of the vehicle, the object information, and the blind spot information; and a control unit which performs driving control of the vehicle. The route generation unit includes a route calculation unit which calculates the traveling route on which the vehicle travels, and a traveling determination unit which determines whether or not traveling is possible on the calculated traveling route. The route calculation unit calculates a first traveling route for avoiding the object, on the basis of the acquired object information. The traveling determination unit determines whether or not the first traveling route passes through the blind spot area due to the object. If it is determined that the first traveling route passes through the blind spot area, the traveling determination unit estimates whether or not the sensor unit mounted to the vehicle is able to detect the blind spot area on an assumption that the vehicle travels on the first traveling route. If it is estimated that the sensor unit is able to detect the blind spot area, the traveling determination unit determines whether or not traveling is possible, and the control unit controls the vehicle so as to travel along the first traveling route in accordance with a determination result for whether or not traveling is possible. If it is estimated that the sensor unit is unable to detect the blind spot area, the traveling determination unit determines that traveling is impossible, and the route calculation unit calculates a second traveling route for avoiding the blind spot area or the control unit causes the vehicle to wait.

According to the present disclosure, it becomes possible to provide a vehicle control device and a vehicle traveling system that can reduce the waiting period for the blind spot area.

### BRIEF DESCRIPTION OF THE DRAWINGS

FIG. 1 shows a vehicle traveling system according to the first embodiment of the present disclosure;

FIG. 2 is a function block diagram showing the configuration of a road side unit according to the first embodiment;

FIGS. 3A and 3B illustrate a blind spot generation mechanism due to an object and a calculation method for a blind spot area, FIG. 3A showing a side view and FIG. 3B showing a plan view;

FIG. 4 is a function block diagram showing the configuration of a fusion server according to the first embodiment;

FIG. 5 is a block diagram showing the configuration of a vehicle control device mounted to a vehicle according to the first embodiment;

FIG. 6 illustrates the relationship between a blind spot area and a traveling route;

FIG. 7 illustrates a method for estimating whether or not a blind spot area can be compensated in the vehicle traveling system according to the first embodiment;

FIGS. 8A to 8D illustrate a procedure for estimating whether or not a blind spot area can be compensated in the vehicle traveling system according to the first embodiment, in the order from FIG. 8A to FIG. 8D;

FIG. 9 shows another example for illustrating a method for estimating whether or not a blind spot area can be compensated in the vehicle traveling system according to the first embodiment;

FIG. 10 illustrates a detection area of a sensor mounted to a vehicle;

FIG. 11 illustrates an example in which it is estimated that a blind spot area cannot be compensated;

FIG. 12 is a flowchart showing operations of the vehicle traveling system and the vehicle control device according to the first embodiment;

FIG. 13 is a block diagram showing the configuration of a vehicle control device according to the second embodiment of the present disclosure;

FIG. 14 illustrates a calculation method for an arrival period until arriving at a blind spot area;

FIGS. 15A to 15C illustrate the relationship between the arrival period and a traveling route, FIG. 15A showing an example of a traveling route in a case of an arrival period t1, and FIG. 15B and FIG. 15C showing examples of traveling routes in a case of an arrival period t2;

FIG. 16 is a flowchart showing operations of a vehicle traveling system and the vehicle control device according to the second embodiment;

FIGS. 17A and 17B illustrate an example in which it is estimated that a blind spot area at an intersection can be compensated; and

FIG. 18 shows the hardware configuration of the vehicle traveling system according to each of the first and second embodiments.

### DETAILED DESCRIPTION OF THE PREFERRED EMBODIMENTS OF THE INVENTION

Hereinafter, embodiments of a vehicle traveling system according to the present disclosure will be described with reference to the drawings. In the following embodiments, a vehicle to which the vehicle traveling system is applied is assumed to be capable of traveling by automated driving corresponding to level 3 or 4 defined by Society of Automotive Engineers (SAE) International, for example. In the drawings, the same reference characters denote the same or corresponding parts. Therefore, the detailed description thereof may be omitted to avoid repeating the description.

### First Embodiment

Hereinafter, a vehicle traveling system according to the first embodiment of the present disclosure will be described with reference to the drawings.

### <Device Configuration>

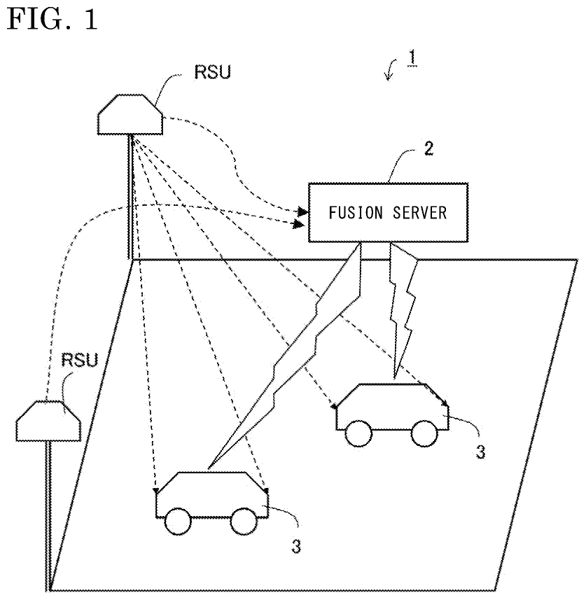

FIG. 1 shows a vehicle traveling system according to the first embodiment. In FIG. 1, the vehicle traveling system 1 includes: road side units RSU which each generate an object area which is an area of an object in a predetermined area, and a blind spot area which is an area as a blind spot for a detection unit due to the object; a fusion server 2 which generates an object area and a blind spot area that are integrated, on the basis of the object areas and the blind spot areas generated by a plurality of the road side units RSU; and automated driving vehicles 3 (hereinafter, simply referred to as vehicles 3) having a function of generating a traveling route.

### <Configuration of Road Side Unit RSU>

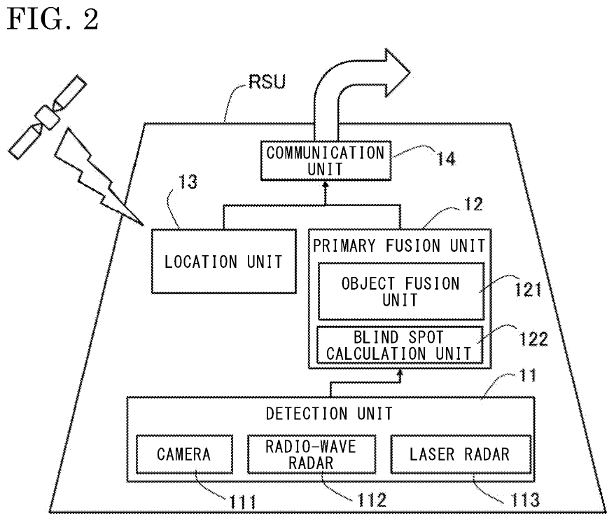

FIG. 2 is a function block diagram showing an example of the configuration of the road side unit RSU. In FIG. 2, each road side unit RSU includes a detection unit 11, a primary fusion unit 12, a location unit 13, and a communication unit 14.

The detection unit 11 includes a sensor capable of detecting object information which is information about an object in a target area, and a support circuit for the sensor. In the first embodiment, the detection unit 11 includes, as the sensor, a camera 111, a radio-wave radar 112, and a laser radar 113, and the object information is information corresponding to detection results from the camera 111, the radio-wave radar 112, and the laser radar 113. The object may be a moving object or a static object.

The primary fusion unit 12 processes the object information detected by the detection unit 11. The primary fusion unit 12 includes an object fusion unit 121 which is an acquisition unit, and a blind spot calculation unit 122 which is an estimation unit. The object fusion unit 121 acquires an object area which is an area of an object in a target area, through calculation or the like, on the basis of the object information detected by the detection unit 11. Also, the object fusion unit 121 determines whether or not the object is a static object or a moving object. The blind spot calculation unit 122 estimates a blind spot area which is an area as a blind spot for the detection unit 11 due to the object, through calculation or the like, on the basis of the calculated object area.

The location unit 13 acquires the position of the road side unit RSU and the direction (e.g., orientation) of the road side unit RSU. The location unit 13 includes a positioning module of a global navigation satellite system (GNSS) such as GPS, Beidou, Galileo, GLONASS, NAVIC, or a quasi-zenith satellite system such as Michibiki, and orientation measurement means using an inertial mechanism such as a gyro, for example.

The communication unit 14 transmits information about the object area and the blind spot area from the primary fusion unit 12 and information about the position and the direction of the road side unit RSU acquired by the location unit 13, to the fusion server 2. The communication unit 14 includes a general communication device or a device for a dedicated communication network, for example.

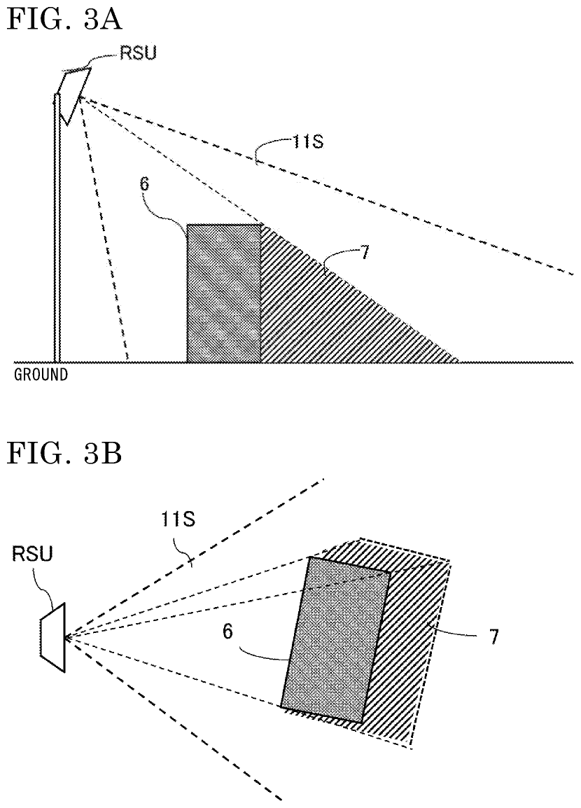

FIGS. 3A and 3B illustrate a blind spot generation mechanism due to an object and a calculation method for a blind spot area. FIG. 3A is a side view as seen in the horizontal direction of the ground, and FIG. 3B is a plan view as seen in the vertical direction of the ground. In FIGS. 3A and 3B, a detection range 11S of the road side unit RSU is indicated by an area between broken lines, and an object 6 in the detection area and a blind spot 7 for the road side unit RSU generated due to the object 6, are shown. That is, in FIG. 3A and FIG. 3B, an object area which is an area of the object 6 and can be detected by the road side unit RSU is shown, and a blind spot area which is an area of the blind spot 7 and cannot be detected by the road side unit RSU is shown on an opposite side across the object 6. The blind spot area which is the area of the blind spot 7 can be obtained through geometric calculation on the basis of the object area. For example, this may be calculated by a method shown in Patent Document 1.

### <Configuration of Fusion Server 2>

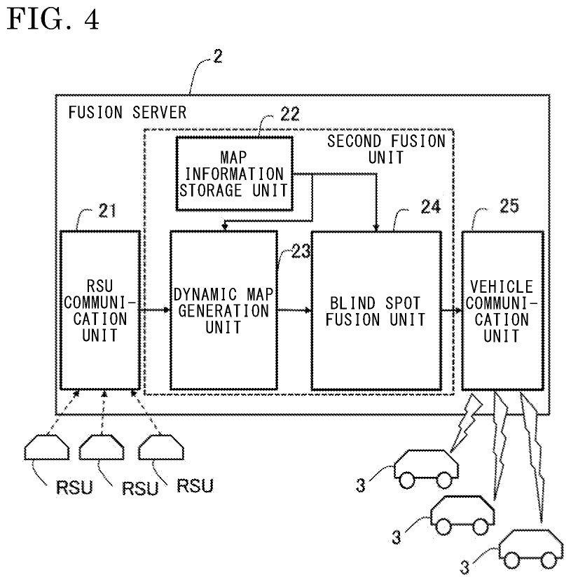

FIG. 4 is a function block diagram showing the configuration of the fusion server 2 according to the first embodiment. In FIG. 4, the fusion server 2 includes an RSU communication unit 21 which communicates with the road side unit RSU, a map information storage unit 22 having map information, a dynamic map generation unit 23 which generates a dynamic map, a blind spot fusion unit 24 which integrates information about blind spot areas estimated by the road side units RSU, and a vehicle communication unit 25 which communicates with the vehicles 3. The map information storage unit 22, the dynamic map generation unit 23, and the blind spot fusion unit 24 correspond to a second fusion unit.

The RSU communication unit 21 receives information about the object areas, the blind spot areas, and the like from the plurality of road side units RSU. The RSU communication unit 21 establishes synchronization with the plurality of road side units RSU by known technology.

The map information storage unit 22 has stored therein narrow-area map information, and provides the map information to the dynamic map generation unit 23. The dynamic map generation unit 23 generates a dynamic map by adding object area information acquired by the RSU communication unit 21 to static map information acquired by the map information storage unit 22.

The blind spot fusion unit 24 integrates blind spot information acquired by the RSU communication unit 21 by referring to the dynamic map. The blind spot information may be added onto the dynamic map.

The vehicle communication unit 25 transmits the dynamic map with the object information added, and the integrated blind spot information, to the vehicles 3 in the area.

### <Configuration of Vehicle Control Device 30>

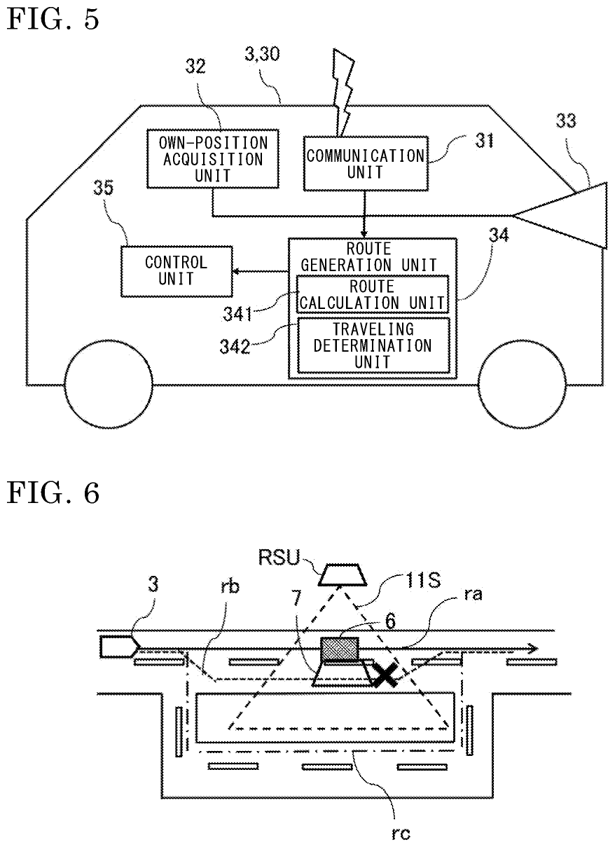

FIG. 5 is a function block diagram showing the configuration of the vehicle control device 30 mounted to the vehicle 3 according to the first embodiment. In FIG. 5, the vehicle control device 30 includes a communication unit 31 which communicates with the fusion server 2, an own-position acquisition unit 32 which acquires the own position of the vehicle 3, a sensor unit 33 which detects an object around the own vehicle to acquire object information, a route generation unit 34 which generates a route on which automated driving is performed, and a control unit 35 which drives the vehicle 3.

The communication unit 31 communicates with the fusion server 2, to receive the object information and the blind spot information integrated by the fusion server 2, together with the dynamic map.

The own-position acquisition unit 32 measures and acquires the position and the direction (e.g., orientation) of the own vehicle by a method similar to that in the location unit 13 of the road side unit RSU. The position and the direction of the own vehicle acquired by the own-position acquisition unit 32 is represented in a global coordinate system.

The sensor unit 33 includes a sensor so as to be able to detect an object (obstacle) in a certain range frontward of the vehicle 3, as with the detection unit 11 of the road side unit RSU. The sensor unit 33 may also include a support circuit. The sensor includes at least one of a camera and a radar (radio-wave radar, laser radar). The sensor may include a sonar sensor. In the present embodiment, the sensor unit 33 needs to be able to detect at least a frontward object, but may be able to detect a surrounding area including not only a frontward area but also lateral areas and a rearward area.

The camera is provided at such a position that the camera can take an image of frontward, lateral, and/or rearward areas around the own vehicle, and acquires information indicating the environment where the vehicle is present, such as information about lanes and obstacles frontward of the own vehicle, from the taken image.

The radio-wave radar radiates radio waves frontward of the own vehicle and detects reflected waves thereof, thereby measuring a relative distance and a relative velocity of an obstacle present frontward of the own vehicle, and outputs the measurement result.

The laser radar is a light detection and ranging (LiDAR) device, for example. The LiDAR radiates a laser beam to an area around the own vehicle and detects a time difference until the laser beam is reflected and returns from a surrounding object, thereby detecting the position of the object.

The sonar sensor radiates an ultrasonic wave to an area around the own vehicle and detects a time difference until the ultrasonic wave is reflected and returns from a surrounding object, thereby detecting the position and the distance at which the object is present.

The route generation unit 34 includes a route calculation unit 341 and a traveling determination unit 342. The route calculation unit 341 calculates a traveling route on which the own vehicle should travel, on the basis of the position of the own vehicle acquired by the own-position acquisition unit 32, object information around the own vehicle acquired by the sensor unit 33, a destination, and the object area, the blind spot area, and the dynamic map (map in global coordinate system) acquired from the fusion server 2. The traveling determination unit 342 determines whether or not traveling is possible on the traveling route calculated by the route calculation unit 341.

The control unit 35 controls the own vehicle so as to travel along the traveling route generated by the route generation unit 34. Specifically, the control unit 35 generates control target values for a vehicle speed, a steering angle, and the like, to drive the vehicle. In a case where the traveling determination unit 342 of the route generation unit 34 determines that traveling is impossible and a new traveling route cannot be generated, the control unit 35 performs control to stop the vehicle.

### <Blind Spot Area and Traveling Route>

FIG. 6 illustrates the relationship between a blind spot area and a traveling route.

In FIG. 6, the vehicle 3 is traveling on a traveling route ra. The traveling route ra is an originally set traveling route to a destination. When the road side unit RSU detects the object 6, a traveling route rb corrected so as to avoid the object is calculated. The corrected traveling route rb passes through the blind spot area of the blind spot 7. Therefore, in the example of Patent Document 1, the vehicle waits or passes through a traveling route rc changed so as to avoid the blind spot area.

### <Method for Estimating Whether Blind Spot Area can be Compensated According to Present Embodiment>

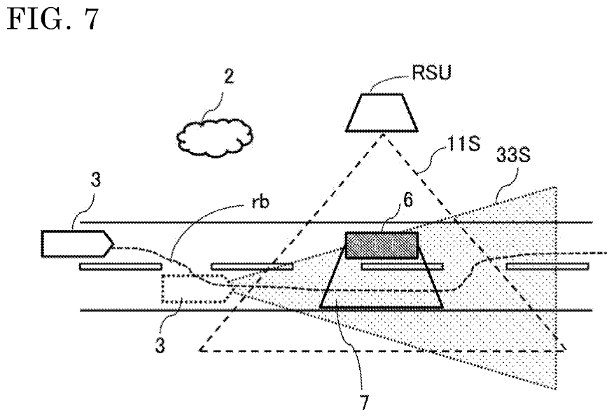

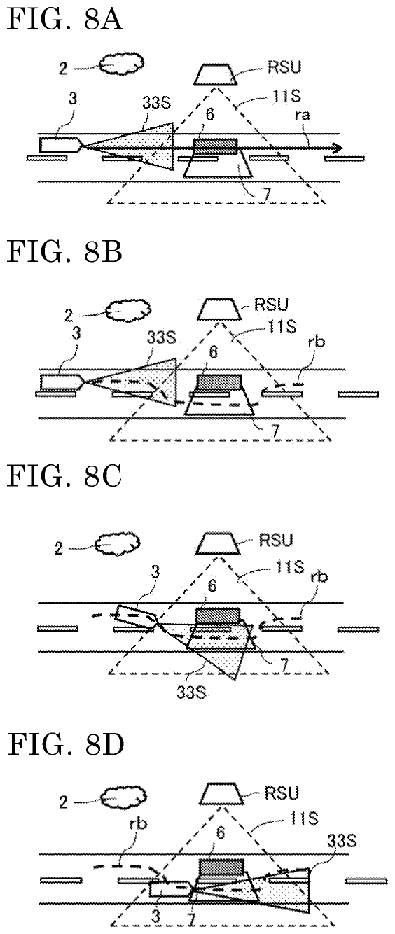

FIG. 7 illustrates a method for estimating whether the blind spot area can be compensated in the vehicle traveling system according to the first embodiment, and FIGS. 8A to 8D illustrate a procedure for estimating whether the blind spot area can be compensated, in the order from FIG. 8A to FIG. 8D. In the vehicle traveling system according to the first embodiment, when the road side unit RSU detects the object 6 as shown in FIG. 8A, the route calculation unit 341 of the vehicle control device 30 calculates the traveling route rb corrected so as to avoid the object as shown in FIG. 8B. The vehicle control device 30 has acquired also the blind spot area from the fusion server 2. In the drawings, a detection range 33S of the sensor unit 33 of the vehicle 3 is indicated by dot-hatched areas.

Meanwhile, the vehicle control device 30 includes the sensor unit 33 which detects an object around the own vehicle to acquire object information. Thus, the traveling determination unit 342 of the vehicle control device 30 determines whether it is possible to travel while the sensor unit 33 detects the blind spot area on an assumption that the vehicle travels on the traveling route rb. FIG. 8C and FIG. 8D show transition of the position of the vehicle 3 and the detection range 33S of the sensor unit 33 on the assumption that the vehicle 3 travels on the traveling route rb. For example, in FIG. 7, whether the detection range 33S of the sensor unit 33 of the vehicle 3 indicated by dotted lines can cover the blind spot area during traveling on the traveling route rb, is calculated, and whether the blind spot area is compensated by being covered by the sensor unit 33 of the vehicle 3 as shown in FIG. 7, is estimated.

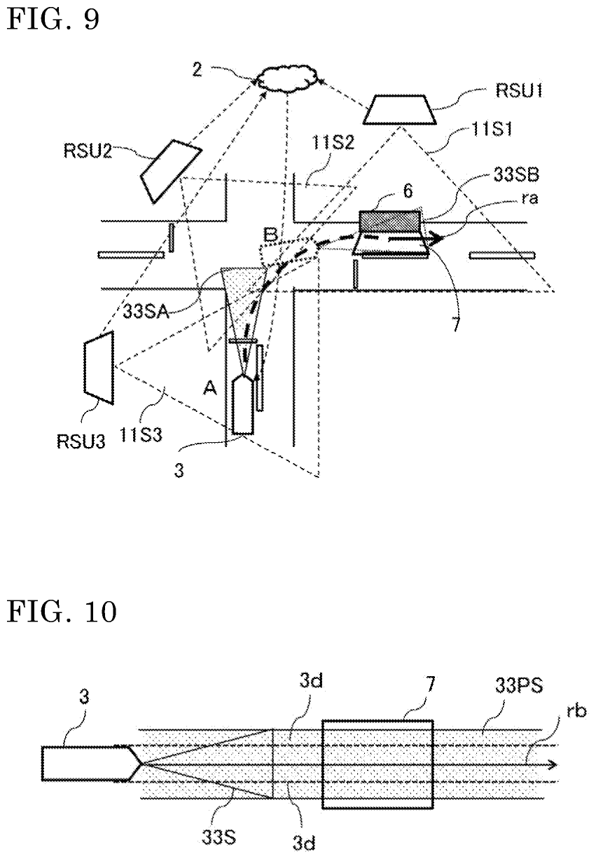

FIG. 9 shows another example for illustrating a method for estimating whether the blind spot area can be compensated in the vehicle traveling system according to the first embodiment, and shows a case of an intersection. At the intersection, a plurality of road side units RSU1, RSU2, RSU3 for monitoring the intersection area from different directions are provided and have detection ranges 11S1, 11S2, 11S3, respectively. The vehicle 3 is planned to turn right at the intersection. On a lane after right turn along the traveling route ra, the object area where the object 6 is detected by the road side unit RSU1 and the blind spot area of the blind spot 7 are present. The object area and the blind spot area cannot be covered by the detection ranges 11S2, 11S3 of the other road side units RSU2, RSU3.

The vehicle control device 30 acquires the blind spot area from the fusion server 2, and the route calculation unit 341 calculates whether the present traveling route ra passes through the blind spot area. Then, the traveling determination unit 342 of the vehicle control device 30 determines whether it is possible to travel while the sensor unit 33 detects the blind spot area on the assumption that the vehicle passes on the traveling route ra. In FIG. 9, when the vehicle 3 is traveling on the traveling route ra, the detection range 33SA of the sensor unit 33 at a point A does not reach the blind spot area. Then, whether the detection range 33SB of the sensor unit 33 of the vehicle 3 at a point B indicated by a dotted line when the vehicle 3 further travels can cover the blind spot area, is calculated, and whether the blind spot area can be compensated by being covered by the detection range 33SB of the sensor unit 33 of the vehicle 3 as in FIG. 9, is estimated. If the blind spot area can be compensated, the traveling determination unit 342 determines that traveling is possible.

As shown in FIGS. 7 to 9, even in a case where the traveling route passes through the blind spot area, the traveling determination unit 342 estimates whether the blind spot area can be compensated on the assumption that the vehicle 3 travels on the route, and if it is estimated that the blind spot area can be compensated, the traveling determination unit 342 determines that traveling is possible. Therefore, the fact that the blind spot area is merely present does not directly lead to selection of waiting. Thus, a waiting period can be reduced.

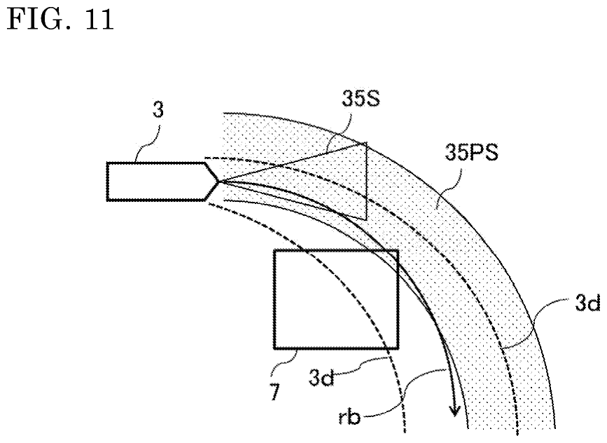

Next, the traveling route of the vehicle and estimation for whether the blind spot area can be compensated will be described in more detail. FIG. 10 illustrates an example in which it is estimated that the blind spot area can be compensated and it is determined that traveling is possible, and FIG. 11 illustrates an example in which the blind spot area cannot be compensated and it is determined that traveling is impossible.

FIG. 10 shows a state in which the vehicle 3 is traveling on the traveling route rb passing through the area of the blind spot 7. In FIG. 10, predicted traveling area boundaries 3d representing boundaries within which the vehicle 3 is predicted to be present when the vehicle 3 travels along the traveling route rb from the present location, and a predicted sensing area 33PS cumulatively representing transition of a detection range 33S of the sensor unit 33 of the vehicle 3, are shown. The predicted sensing area 33PS is a dot-hatched area. In the case where the vehicle 3 travels along the traveling route rb, the inside of the predicted traveling area boundaries 3d where the vehicle 3 passing through the blind spot area is present is a part of the blind spot area and the predicted sensing area 33PS cannot cover the entire blind spot area, but it is possible to detect an object in a range over the predicted traveling area boundaries 3d. Therefore, in the case where, in the blind spot area, the predicted traveling area boundaries 3d are present within the predicted sensing area 33PS, the traveling determination unit 342 estimates that the blind spot area can be compensated and determines that traveling is possible.

FIG. 11 shows an example in which the vehicle 3 travels on a curved road, and as in FIG. 10, predicted traveling area boundaries 3d representing boundaries predicted to be a presence range of the vehicle 3 when the vehicle 3 travels along the traveling route rb, and a predicted sensing area 33PS cumulatively representing transition of the detection range 33S of the sensor unit 33 of the vehicle 3, are shown. In FIG. 11, in the case where the vehicle 3 travels along the traveling route rb, the predicted sensing area 33PS at the time of passing through the area of the blind spot 7 cannot cover the inside of the predicted traveling area boundaries 3d. Therefore, in this case, the traveling determination unit 342 estimates that the blind spot area cannot be compensated and determines that traveling is impossible.

That is, in a case where the vehicle 3 travels along a traveling route including a blind spot area, the traveling determination unit 342 calculates the predicted traveling area boundaries 3d and the predicted sensing area 33PS, and estimates whether or not the predicted sensing area 33PS at the time of passing through the blind spot area can cover the inside of the predicted traveling area boundaries 3d. Then, if it is estimated that the predicted sensing area 33PS can cover the inside of the predicted traveling area boundaries 3d, the traveling determination unit 342 estimates that the blind spot area will be compensated and determines that traveling is possible.

While it is estimated that the blind spot area can be compensated, in a case where the vehicle 3 will enter the opposite lane as shown in FIG. 7, the traveling determination unit 342 acquires object information ahead of the blind spot area from the road side unit RSU and the fusion server 2, acquires object information rearward of the vehicle 3 from the road side unit RSU, the fusion server 2, and a sensor for performing rearward detection of the sensor unit 33, and determines whether there is no possibility of collision or the like in areas other than the blind spot area, thereby determining whether or not traveling is possible.

### <Operations of Vehicle Traveling System 1 and Vehicle Control Device 30 According to First Embodiment>

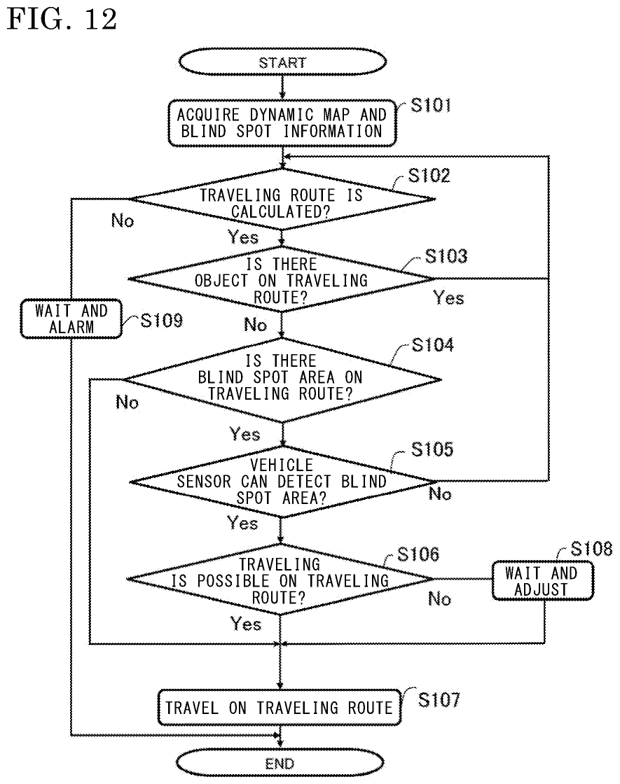

Next, with reference to a flowchart in FIG. 12, operation of the vehicle traveling system 1 according to the first embodiment will be described focusing on operation of the vehicle control device 30. The process in the flowchart in FIG. 12 is repeatedly executed during traveling of the vehicle 3. Steps in FIG. 12 will be described in association with the function units shown in the function block diagrams in FIGS. 2, 4, and 5.

First, each road side unit RSU transmits information about an object area and information about a blind spot area detected in the detection range 11S, together with information about the position and the direction of the road side unit RSU, to the fusion server 2. The fusion server 2 integrates information about the object areas and information about the blind spot areas collected from the road side units RSU, to generate a dynamic map, and transmits the dynamic map with the object information added and information about the blind spot areas, to the vehicle 3 in a target area.

In step S101, the communication unit 31 of the vehicle control device 30 acquires the dynamic map with the object information added and the information about the blind spot areas from the fusion server 2.

Next, in step S102, the route calculation unit 341 of the route generation unit 34 calculates a traveling route for the vehicle 3 on the basis of the own position acquired by the own-position acquisition unit 32 and the dynamic map with the object information added and the information about the blind spot areas acquired from the fusion server 2. The original traveling route ra may be generated in advance on the basis of the destination and the map information.

In step S102, when the traveling route has been calculated (Yes in step S102), the process proceeds to step S103. In step S103, if there is an object 6 which is an obstacle on the traveling route (Yes in step S103), the process returns to step S102 and the route calculation unit 341 generates a traveling route for avoiding the object 6. If there are no objects on the traveling route, the process proceeds to step S104 (No in step S103).

Next, in step S104, if the route calculation unit 341 determines that there is a blind spot area on the traveling route (Yes in step S104), the process proceeds to step S105. If there are no blind spot areas on the traveling route (No in step S104), the process proceeds to step S107.

If it is determined that there is a blind spot area on the traveling route, in step S105, the traveling determination unit 342 estimates whether the sensor unit 33 mounted to the vehicle 3 can detect the blind spot area, i.e., the blind spot area can be compensated, when the vehicle 3 travels on the route. If it is estimated that the blind spot area can be compensated (Yes in step S105), the process proceeds to step S106. If it is estimated that the blind spot area cannot be compensated because the sensor unit 33 cannot detect the blind spot area (No in step S105), the process returns to step S102, to generate a traveling route for avoiding the blind spot area.

If it is estimated that the blind spot area can be compensated by the sensor unit 33, in step S106, the traveling determination unit 342 determines whether there is no possibility of collision or the like in areas other than the blind spot area, thereby determining whether or not traveling is possible. Specifically, on a large-width road, in a case where the blind spot area is within the lane, it may be determined that traveling is possible only from estimation that the blind spot area can be compensated by the sensor unit 33. In a case where the blind spot area is on an opposite lane, object information ahead of the blind spot area is acquired from the road side unit RSU and the fusion server 2, object information rearward of the vehicle 3 is acquired from the road side unit RSU, the fusion server 2, and the sensor for performing rearward detection of the sensor unit 33, and whether there is no possibility of collision with another object, or the like, in areas other than the blind spot area, is determined, thereby determining whether or not traveling is possible. In a case where the blind spot area is on an overtaking lane, object information is acquired from the sensor for performing detection rearward of the vehicle 3, of the sensor unit 33, and whether there is no possibility of rear-end collision by a rearward vehicle, or the like, is determined, thereby determining whether or not traveling is possible.

In step S106, if it is determined that traveling is possible on the traveling route (Yes in step S106), the process proceeds to step S107 and the control unit 35 controls the vehicle 3 so as to travel along the generated traveling route. In step S106, if it is determined that traveling is impossible (No in step S106), in a case of an opposite lane, it is necessary to wait until mainly a vehicle from the front side passes by, or in a case of an overtaking lane, it is necessary to wait until a rearward vehicle already present on the overtaking lane passes by, and therefore the control unit 35 causes the vehicle 3 to wait until such a vehicle passes by (step S108). Then, the process proceeds to step S107 and the control unit 35 causes the vehicle 3 to travel along the traveling route.

In a case where the process returns to step S102 from step S103 or step S105 and a traveling route for avoiding the object area or the blind spot area cannot be calculated (No in step S102), the process proceeds to step S109, and the control unit 35 controls the vehicle 3 so as to stop the vehicle 3 at a position before the object area or the blind spot area, and as necessary, issues an alarm. In addition, as in Patent Document 1, whether to wait or generate a detour route, or the like, may be determined on the basis of whether the object is a static object or a moving object.

As described above, according to the first embodiment, the vehicle control device controls traveling of a vehicle while acquiring object information about an object detected by a road side unit and blind spot information including a blind spot area as a blind spot for the road side unit due to the object, and includes: an own-position acquisition unit which acquires an own position of the vehicle; a sensor unit which performs detection at least frontward of the vehicle; a route generation unit which generates a traveling route on which a vehicle travels, using the own position of the vehicle and the acquired object information and blind spot information; and a control unit which performs driving control of the vehicle. The route generation unit includes a route calculation unit which calculates the traveling route on which the vehicle travels, and a traveling determination unit which determines whether or not traveling is possible on the calculated traveling route. The route calculation unit calculates a first traveling route for avoiding the object on the basis of the acquired object information. The traveling determination unit determines whether or not the first traveling route passes through the blind spot area. If it is determined that the first traveling route passes through the blind spot area, the traveling determination unit estimates whether or not the sensor unit is able to detect the blind spot area on an assumption that the vehicle travels on the first traveling route. If it is estimated that the sensor unit is able to detect the blind spot area, the control unit controls the vehicle so as to travel along the first traveling route. Thus, even when there is a blind spot area, it is not necessary to wait, if it is estimated that the sensor of the own vehicle can detect the blind spot area, so that the waiting period can be reduced.

In addition, the vehicle traveling system includes: a road side unit including a detection unit which detects an object in a predetermined area, and a blind spot calculation unit which, on the basis of object information about the detected object, calculates a blind spot area as a blind spot for the road side unit due to an object; a fusion server which integrates the object information and blind spot information acquired from one or a plurality of the road side units and transmits the integrated information to the vehicle; and a vehicle to which the above vehicle control device is mounted. Thus, the vehicle traveling system can reduce the waiting period and achieve smooth traveling of an automated driving vehicle.

### Second Embodiment

Hereinafter, a vehicle traveling system according to the second embodiment of the present disclosure will be described with reference to the drawings.

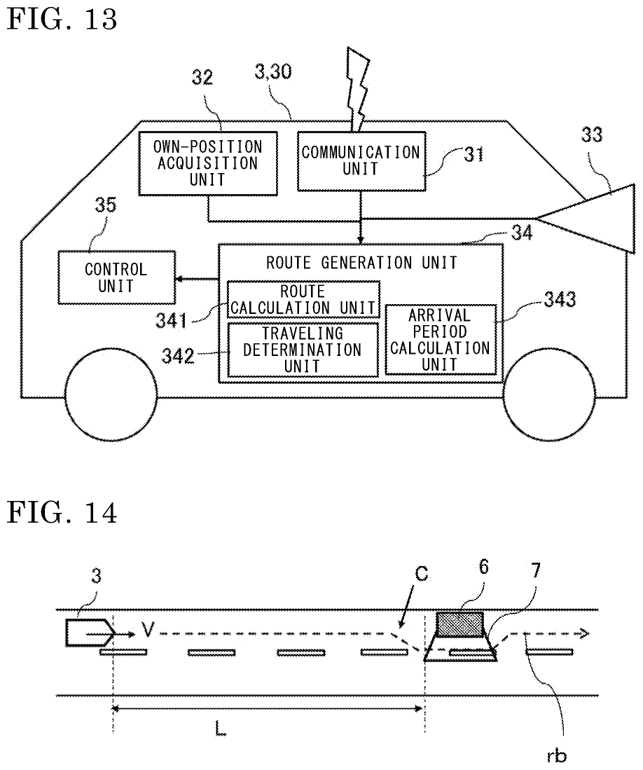

FIG. 13 is a function block diagram of the vehicle control device 30 according to the second embodiment. Difference from FIG. 5 in the first embodiment is that the route generation unit 34 further includes an arrival period calculation unit 343. Other than this, the configurations of the road side unit RSU and the fusion server 2 are the same as in the first embodiment and the description thereof is omitted.

Operation of the arrival period calculation unit 343 included in the route generation unit 34 will be described. The arrival period calculation unit 343 calculates an arrival period taken until the vehicle 3 arrives at a blind spot area from the present location. FIG. 14 illustrates a calculation method for the arrival period until arriving at the blind spot area. An arrival period t until arriving at the blind spot area from the present location of the vehicle 3 can be calculated by t=L/V from a traveling speed V of the vehicle 3 and a distance L between the vehicle 3 and the blind spot area.

The traveling determination unit 342 compares the arrival period t calculated by the arrival period calculation unit 343 with a predetermined threshold th_t, and in a case of t>th_t, estimates whether the sensor unit 33 mounted to the vehicle 3 can detect the blind spot area, i.e., the blind spot area can be compensated, when the vehicle 3 travels on the route. On the other hand, in a case of t≤th_t, the traveling determination unit 342 determines that traveling is impossible.

As shown in FIG. 14, on the traveling route rb, lane change is performed at a point C so as to avoid the object area and enter the blind spot area. At this time, in a case of t≤th_t, it is necessary to perform sharp steering operation just before the object area or the point C is inevitably set near the object area, so that there is a risk such as delay of the timing for the vehicle 3 to detect the blind spot area. Therefore, in the case of t≤th_t, it is determined that traveling is impossible.

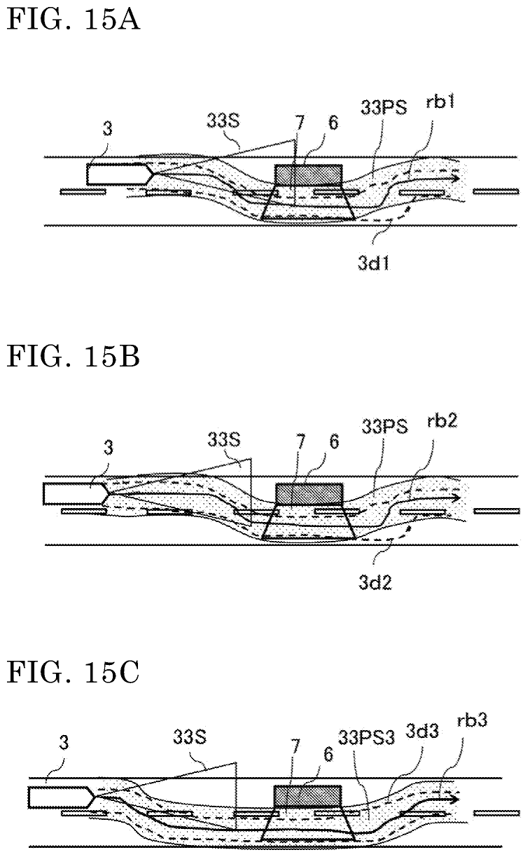

FIGS. 15A to 15C show three traveling routes in a case of t>th_t. FIG. 15A shows an example in which the arrival period until arriving at the blind spot area is t1, and FIGS. 15B and 15C show examples in which the arrival period until arriving at the blind spot area is t2. Here, t2>t1>th_t is satisfied. In all the three examples, when the vehicle 3 travels on the route, the sensor unit 33 mounted to the vehicle 3 can detect the blind spot area. In FIG. 15B, a traveling route rb2 to enter the blind spot area just before the object area is generated as in a traveling route rb1 in FIG. 15A, but since the arrival period until arriving at the blind spot area is long, it is possible to correct the traveling route to a traveling route rb3 on which, as shown in FIG. 15C, the vehicle 3 will make mild lane change and a state in which the sensor unit 33 can detect the blind spot area can be made earlier.

### <Operations of Vehicle Traveling System 1 and Vehicle Control Device 30 According to Second Embodiment>

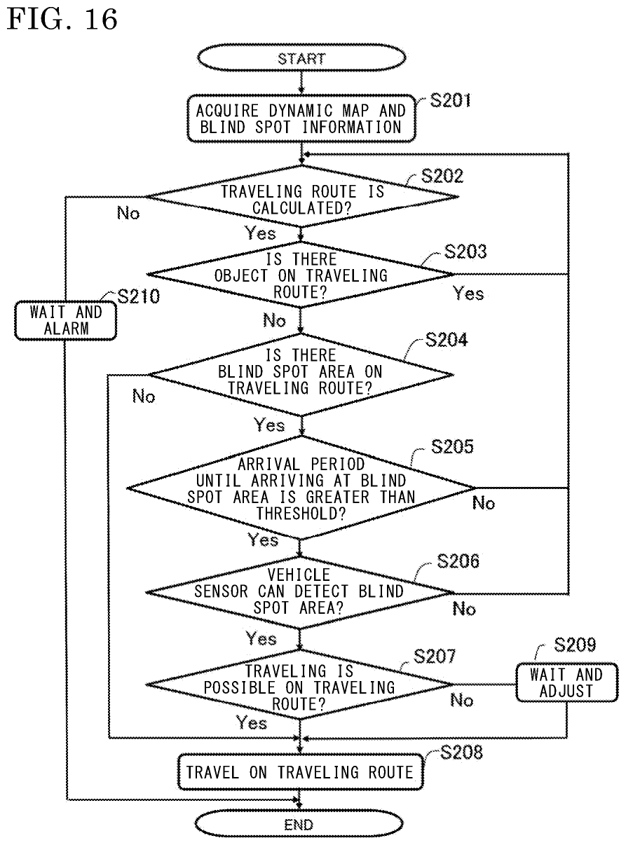

Next, operation of the vehicle traveling system 1 according to the second embodiment will be described focusing on operation of the vehicle control device 30, with reference to a flowchart in FIG. 16. A process in the flowchart in FIG. 16 is repeatedly executed during traveling of the vehicle 3.

Steps S201 to S204 are the same as steps S101 to S104 in FIG. 12 in the first embodiment and the description thereof is omitted.

In step S204, if it is determined that there is a blind spot area on the traveling route, the process proceeds to step S205 and the arrival period calculation unit 343 calculates the arrival period t until the vehicle 3 arrives at the blind spot area from the present location. The traveling determination unit 342 compares the arrival period t calculated by the arrival period calculation unit 343 with the predetermined threshold th_t. In a case of t>th_t (Yes in step S205), the process proceeds to step S206. In a case of t≤th_t, the traveling determination unit 342 determines that traveling is impossible (No in step S205) and the process returns to step S202, to calculate a traveling route again.

In step S206, the traveling determination unit 342 estimates whether the sensor unit 33 mounted to the vehicle 3 can detect the blind spot area, i.e., the blind spot area can be compensated, on the assumption that the vehicle 3 travels on the route. If it is estimated that the blind spot area can be compensated (Yes in step S206), the process proceeds to step S207. If it is estimated that the blind spot area cannot be compensated because the sensor unit 33 cannot detect the blind spot area (No in step S206), the process returns to step S202, to generate a traveling route for avoiding the blind spot area.

If it is estimated that the blind spot area can be compensated by the sensor unit 33, in step S207, the traveling determination unit 342 determines whether there is no possibility of collision or the like in areas other than the blind spot area, thereby determining whether or not traveling is possible. The determination for whether or not traveling is possible is the same as in step S106 and the description thereof is omitted.

In step S207, if it is determined that traveling is possible on the traveling route (Yes in step S207), the process proceeds to step S208 and the control unit 35 controls the vehicle 3 so as to travel along the generated traveling route. In step S207, if it is determined that traveling is impossible (No in step S207), in a case of an opposite lane, it is necessary to wait until mainly a vehicle from the front side passes by, or in a case of an overtaking lane, it is necessary to wait until a rearward vehicle already present on the overtaking lane passes by, and therefore the control unit 35 causes the vehicle 3 to wait until such a vehicle passes by (step S209). Then, the process proceeds to step S208 and the control unit 35 causes the vehicle 3 to travel along the traveling route.

In a case where the process returns to step S202 from step S203, step S205, or step S206 and a traveling route for avoiding the object area or the blind spot area cannot be calculated (No in step S202), the process proceeds to step S210, and the control unit 35 controls the vehicle 3 so as to stop the vehicle 3 at a position before the object area or the blind spot area, and as necessary, issues an alarm. In addition, as in Patent Document 1, whether to wait or generate a detour route, or the like, may be determined on the basis of whether the object is a static object or a moving object.

As described above, according to the second embodiment, the same effects as in the first embodiment are provided. In addition, the route generation unit of the vehicle control device further includes an arrival period calculation unit which, if the traveling determination unit determines that the first traveling route passes through the blind spot area due to the object, calculates an arrival period until arriving at the blind spot area from a present location of the vehicle. The traveling determination unit compares the calculated arrival period t with a predetermined threshold th_t, and if the arrival period is the threshold or smaller (t≤th_t), the route calculation unit calculates a second traveling route for avoiding the blind spot area or the control unit causes the vehicle to wait. Thus, it becomes possible to restructure a traveling route without forcibly estimating whether the blind spot area can be compensated. Further, if the arrival period is greater than the threshold (t>th_t), the route calculation unit can perform correction so that lane change through the first traveling route becomes mild, as necessary, whereby a smooth traveling route can be provided.

Even in a case where, in step S105 in the first embodiment and step S206 in the second embodiment, the sensor unit 33 cannot detect the blind spot area and it is estimated that the blind spot area cannot be compensated, if a proportion of a part that cannot be compensated in the blind spot area is a predetermined proportion or smaller, the traveling determination unit 342 may perform correction for the traveling route so as to compensate the blind spot area. This proportion differs depending on conditions such as the traveling route, the blind spot area, the position of the vehicle, and the direction of the vehicle. Therefore, this proportion may be set in advance as a tuning parameter together with the above conditions. Depending on the conditions, if the proportion of a part that cannot be compensated when it is estimated that the blind spot area cannot be compensated is, for example, 5% or smaller, it becomes possible to generally compensate the blind spot area by the following correction.

For example, as shown in the relationship between FIG. 15B and FIG. 15C, the change position of the traveling route for the vehicle 3 may be changed to a position away from the object area or the blind spot area, and by performing change in this way, it becomes possible to compensate the blind spot area.

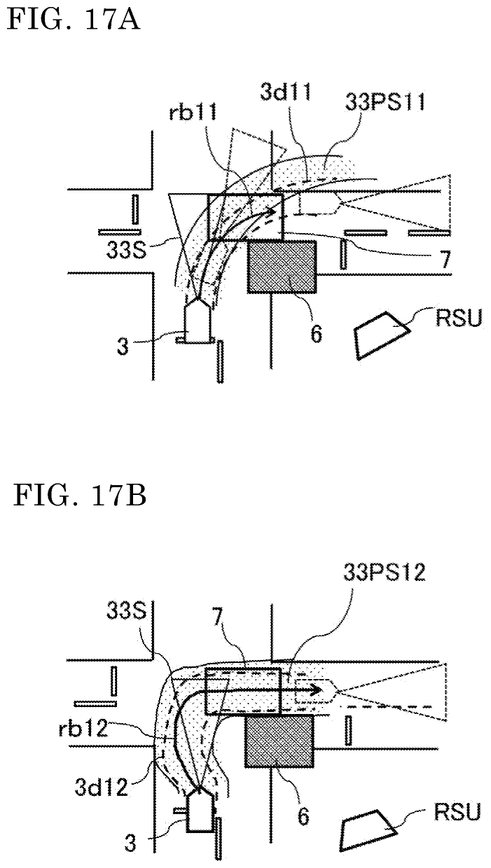

FIGS. 17A and 17B show examples at an intersection. In a case where the vehicle 3 travels along a traveling route rb11 in FIG. 17A, predicted traveling area boundaries 3d11 in a blind spot area cannot be fully covered by a predicted sensing area 33PS11. However, in FIG. 17B, a right-turn route is generated so as to protrude like a traveling route rb12, whereby the inside of predicted traveling area boundaries 3d12 in the blind spot area can be covered by a predicted sensing area 33PS12. If the traveling determination unit 342 has such a function of performing slight correction as described above, it becomes unnecessary to return to the step of calculating a traveling route again, thus contributing to further reduction of the waiting period of the vehicle 3.

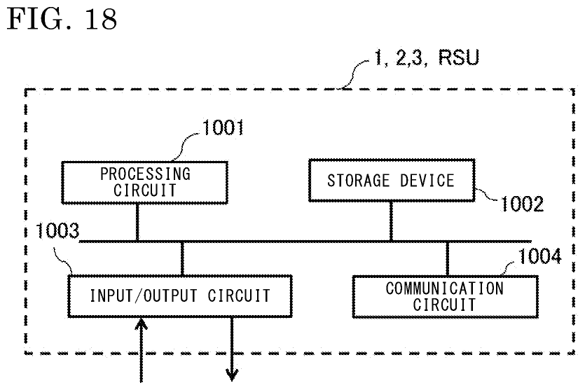

The functions of the vehicle traveling system 1, the fusion server 2, the vehicle control device 30, and the road side unit RSU in the above first and second embodiments may be implemented by a hardware configuration exemplified in FIG. 18, i.e., the vehicle traveling system 1 composed of a processing circuit 1001, a storage device 1002 including a read only memory (ROM) storing a program for executing the function of each function unit and a random access memory (RAM) for storing data of an execution result of each function unit which is a calculation result by the program, an input/output circuit 1003, and a communication circuit 1004.

As the processing circuit 1001, a processor such as a central processing unit (CPU) or a digital signal processor (DSP) is used. As the processing circuit 1001, dedicated hardware may be used. In a case where the processing circuit 1001 is dedicated hardware, the processing circuit 1001 is, for example, a single circuit, a complex circuit, a programmed processor, a parallel-programmed processor, an application specific integrated circuit (ASIC), a field-programmable gate array (FPGA), or a combination thereof.

The function units of the vehicle traveling system 1, the fusion server 2, the vehicle control device 30, and the road side unit RSU may be each implemented by an individual processing circuit, or may be collectively implemented by one processing circuit.

Regarding the function units of the vehicle traveling system 1, the fusion server 2, the vehicle control device 30, and the road side unit RSU, some of the functions may be implemented by a processing circuit as dedicated hardware, and other functions may be implemented by software, for example. Thus, the functions described above may be implemented by hardware, software, etc., or a combination thereof.

The communication circuit 1004 includes a long-range communication unit and a short-range communication unit as a communication module. As the long-range communication unit, the one compliant with a predetermined long-range wireless communication standard such as long term evolution (LTE) or fourth/fifth-generation mobile communication system (4G/5G) is used. For the short-range communication unit, for example, dedicated short range communications (DSRC) are used, and although not described in the above embodiments, the short-range communication unit may be used for communication with another vehicle, whereby information of another vehicle around the own vehicle can be acquired. For these communications, certain communication speeds are ensured.

In the vehicle 3, for example, Control Area Network (CAN) (registered trademark) is used for making connection to perform information communication.

### OTHER EMBODIMENTS

In the above description, an automobile which is a vehicle has been shown as an example. However, without limitation thereto, the present disclosure is also applicable to other various movable bodies. The present disclosure is applicable as a system for generating a traveling route for a movable body such as an in-building movable robot for inspecting the inside of a building, a line inspection robot, or a personal mobility, for example. In a case where the movable body is other than an automobile, for example, information from an obstacle information detection unit provided in a building, a line, or a range in which a personal mobility moves may be used instead of information acquired by the road side unit RSU.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

Hereinafter, modes of the present disclosure are summarized as additional notes.

### (Additional Note 1)

A vehicle control device which controls traveling of a vehicle while acquiring object information about an object detected by a road side unit, and blind spot information including a blind spot area as a blind spot for the road side unit due to the object, estimated on the basis of the object information, the vehicle control device comprising:
an own-position acquisition unit which acquires a position of the vehicle;
a sensor unit which performs detection at least frontward of the vehicle;
a route generation unit which generates a traveling route on which the vehicle travels, using the position of the vehicle, the object information, and the blind spot information; and
a control unit which performs driving control of the vehicle, wherein
the route generation unit includes a route calculation unit which calculates the traveling route on which the vehicle travels, and a traveling determination unit which determines whether or not traveling is possible on the calculated traveling route,
the route calculation unit calculates a first traveling route for avoiding the object, on the basis of the acquired object information,
the traveling determination unit determines whether or not the first traveling route passes through the blind spot area due to the object,
if it is determined that the first traveling route passes through the blind spot area, the traveling determination unit estimates whether or not the sensor unit mounted to the vehicle is able to detect the blind spot area on an assumption that the vehicle travels on the first traveling route,
if it is estimated that the sensor unit is able to detect the blind spot area, the traveling determination unit determines whether or not traveling is possible, and the control unit controls the vehicle so as to travel along the first traveling route in accordance with a determination result for whether or not traveling is possible, and
if it is estimated that the sensor unit is unable to detect the blind spot area, the traveling determination unit determines that traveling is impossible, and the route calculation unit calculates a second traveling route for avoiding the blind spot area or the control unit causes the vehicle to wait.

### (Additional Note 2)

The vehicle control device according to additional note 1, wherein
the route generation unit further includes an arrival period calculation unit which, if the traveling determination unit determines that the first traveling route passes through the blind spot area due to the object, calculates an arrival period until arriving at the blind spot area from a present location of the vehicle,
the traveling determination unit compares the calculated arrival period with a predetermined threshold, and
if the arrival period is the threshold or smaller, the route calculation unit calculates the second traveling route for avoiding the blind spot area or the control unit causes the vehicle to wait.

### (Additional Note 3)

The vehicle control device according to additional note 2, wherein
if the traveling determination unit determines that the arrival period is greater than the threshold, the route calculation unit calculates a route corrected so that lane change through the first traveling route becomes mild.

### (Additional Note 4)

The vehicle control device according to any one of additional notes 1 to 3, wherein
in a case where the traveling determination unit determines that the first traveling route passes through the blind spot area due to the object and estimates that the sensor unit mounted to the vehicle is unable to detect the blind spot area on the assumption that the vehicle travels on the first traveling route, the traveling determination unit calculates a proportion of a part that the sensor unit is unable to detect in the blind spot area, and compares whether or not the proportion of the part that the sensor unit is unable to detect is a predetermined proportion or smaller, and
if it is determined that the proportion of the part that the sensor unit is unable to detect in the blind spot area is the predetermined proportion or smaller, the route calculation unit calculates a corrected route of the first traveling route so that the sensor unit of the vehicle becomes able to detect the blind spot area.

### (Additional Note 5)

A vehicle traveling system comprising:
the road side unit including a detection unit which detects an object in a predetermined area, and a blind spot calculation unit which, on the basis of object information about the detected object, calculates a blind spot area as a blind spot for the road side unit due to the object;
a fusion server which integrates the object information and the blind spot information acquired from one or a plurality of the road side units and transmits the integrated information to the vehicle; and
the vehicle to which the vehicle control device according to any one of additional notes 1 to 4 is mounted.

### DESCRIPTION OF THE REFERENCE CHARACTERS

1 vehicle traveling system
2 fusion server
3 vehicle
3d, 3d1, 3d2, 3d3, 3d11, 3d12 predicted traveling area boundary
6 object
7 blind spot
11 detection unit
11S, 11S1, 11S2, 11S3 detection range
111 camera
112 radio-wave radar
113 laser radar
12 primary fusion unit
121 object fusion unit
122 blind spot calculation unit
13 location unit
14 communication unit
21 RSU communication unit
22 map information storage unit
23 dynamic map generation unit
24 blind spot fusion unit
25 vehicle communication unit
30 vehicle control device
31 communication unit
32 own-position acquisition unit
33 sensor unit
33S, 33SA, 33SB detection range
33PS, 33PS11, 33PS12 predicted sensing area
34 route generation unit
341 route calculation unit
342 traveling determination unit
343 arrival period calculation unit
35 control unit
RSU, RSU1, RSU2, RSU3 road side unit
ra, rb, rc, rb1, rb2, rb3, rb11, rb12 traveling route

What is claimed is:

1. A vehicle control device which controls traveling of a vehicle while acquiring object information about an object detected by a road side device, and blind spot information including a blind spot area as a blind spot for the road side device due to the object, estimated on the basis of the object information, the vehicle control device comprising:
an own-position acquisition circuitry which acquires a position of the vehicle;
a sensor which performs detection at least frontward of the vehicle;
a route generation circuitry which generates a traveling route on which the vehicle travels, using the position of the vehicle, the object information, and the blind spot information; and
a control circuitry which performs driving control of the vehicle, wherein
the route generation circuitry includes a route calculation circuitry which calculates the traveling route on which the vehicle travels, and a traveling determination circuitry which determines whether or not traveling is possible on the calculated traveling route,
the route calculation circuitry calculates a first traveling route for avoiding the object, on the basis of the acquired object information,
the traveling determination circuitry determines whether or not the first traveling route passes through the blind spot area due to the object,
if it is determined that the first traveling route passes through the blind spot area, the traveling determination circuitry estimates whether or not the sensor mounted to the vehicle is able to detect the blind spot area on an assumption that the vehicle travels on the first traveling route,
if it is estimated that the sensor is able to detect the blind spot area, the traveling determination circuitry determines whether or not traveling is possible, and the control circuitry controls the vehicle so as to travel along the first traveling route in accordance with a determination result for whether or not traveling is possible, and
if it is estimated that the sensor is unable to detect the blind spot area, the traveling determination circuitry determines that traveling is impossible, and the route calculation circuitry calculates a second traveling route for avoiding the blind spot area or the control circuitry causes the vehicle to wait.

2. The vehicle control device according to claim 1, wherein
the route generation circuitry further includes an arrival period calculation circuitry which, if the traveling determination circuitry determines that the first traveling route passes through the blind spot area due to the object, calculates an arrival period until arriving at the blind spot area from a present location of the vehicle,
the traveling determination circuitry compares the calculated arrival period with a predetermined threshold, and
if the arrival period is the threshold or smaller, the route calculation circuitry calculates the second traveling route for avoiding the blind spot area or the control circuitry causes the vehicle to wait.

3. The vehicle control device according to claim 2, wherein
if the traveling determination circuitry determines that the arrival period is greater than the threshold, the route calculation circuitry calculates a route corrected so that lane change through the first traveling route becomes mild.

4. The vehicle control device according to claim 1, wherein
in a case where the traveling determination circuitry determines that the first traveling route passes through the blind spot area due to the object and estimates that the sensor mounted to the vehicle is unable to detect the blind spot area on the assumption that the vehicle travels on the first traveling route, the traveling determination circuitry calculates a proportion of a part that the sensor is unable to detect in the blind spot area, and compares whether or not the proportion of the part that the sensor is unable to detect is a predetermined proportion or smaller, and
if it is determined that the proportion of the part that the sensor is unable to detect in the blind spot area is the predetermined proportion or smaller, the route calculation circuitry calculates a corrected route of the first traveling route so that the sensor of the vehicle becomes able to detect the blind spot area.

5. A vehicle traveling system comprising:
the road side device including a detection circuitry which detects an object in a predetermined area, and a blind spot calculation circuitry which, on the basis of object information about the detected object, calculates a blind spot area as a blind spot for the road side device due to the object;
a fusion server which integrates the object information and the blind spot information acquired from one or a plurality of the road side devices and transmits the integrated information to the vehicle; and
the vehicle to which the vehicle control device according to claim 1 is mounted.

6. A vehicle traveling system comprising:
the road side device including a detection circuitry which detects an object in a predetermined area, and a blind spot calculation circuitry which, on the basis of object information about the detected object, calculates a blind spot area as a blind spot for the road side device due to the object;
a fusion server which integrates the object information and the blind spot information acquired from one or a plurality of the road side devices and transmits the integrated information to the vehicle; and
the vehicle to which the vehicle control device according to claim 2 is mounted.

7. A vehicle traveling system comprising:
the road side device including a detection circuitry which detects an object in a predetermined area, and a blind spot calculation circuitry which, on the basis of object information about the detected object, calculates a blind spot area as a blind spot for the road side device due to the object;
a fusion server which integrates the object information and the blind spot information acquired from one or a plurality of the road side devices and transmits the integrated information to the vehicle; and
the vehicle to which the vehicle control device according to claim 3 is mounted.

8. A vehicle traveling system comprising:
the road side device including a detection circuitry which detects an object in a predetermined area, and a blind spot calculation circuitry which, on the basis of object information about the detected object, calculates a blind spot area as a blind spot for the road side device due to the object;
a fusion server which integrates the object information and the blind spot information acquired from one or a plurality of the road side devices and transmits the integrated information to the vehicle; and
the vehicle to which the vehicle control device according to claim 4 is mounted.
